(19) United States
(12) Patent Application Publication
(10) Pub. No.: US 2021/0229976 A1
(43) Pub. Date: Jul. 29, 2021

(54) VALVED CONNECTOR CLOSED LOOP LIQUID DISPENSING SYSTEM

(71) Applicant: SEKO S.P.A., Cittaducale (RI) (IT)

(72) Inventors: Gabriele PETRANGELI, Cittaducale (RI) (IT); Francesco FIORENTINO, Cittaducale (RI) (IT); Luigino ESPOSITO, Cittaducale (RI) (IT); Adrio PANTALEONI, Cittaducale (RI) (IT)

(73) Assignee: SEKO S.P.A., Cittaducale (RI) (IT)

(21) Appl. No.: 15/734,965

(22) PCT Filed: Jun. 12, 2019
(86) PCT No.: PCT/IB2019/054894

§ 371 Date: Dec. 3, 2020

(30) Foreign Application Priority Data
Jun. 12, 2018 (IT) 102018000006223

(51) Int. Cl. B67D 7/02; B65D 47/24; B65D 47/36

(52) U.S. Cl. CPC B67D 7/0294; A47L 15/4418; B65D 47/36; B65D 47/248

(57) ABSTRACT

Closed loop dispensing system comprising dispenser cap 300 connectable to a container receiver 100 and valve 200A, 200B, comprising:—a cup-shaped base 210, insertable into receiver 100, having inlet aperture 214 and longitudinal tunnels 218 which house occlusion elements 260, 265,—a spring support 220 coupled to the cup-shaped base 210 and spaced apart from bottom 212 of cup-shaped base 210 and provided with spring support top sleeve 222,—a movable sealing dome 240 slidably coupled to spring support top sleeve 222 so as to define a variable volume sealed chamber housing elastic element 230,—a locking cover 250 resting on the cup-shaped base 210 and having a locking cover top sleeve 253 surrounding a hole 252, wherein an edge 256 of the hole 252 and the movable sealing dome 240 are configured to be in contact with each other by sealed interference fit when the elastic element 230 assumes the elongated configuration. The dispenser cap comprises outlet aperture 327, vent apertures 325, unlocking member 333 having a bottom cylinder 333 and bottom central duct 335 inside the bottom cylinder and in fluid communication with the outlet aperture; the bottom cylinder can be coupled by interference fit to the locking cover top sleeve; bottom central duct 335 can interact with movable sealing dome 240 in a reduced configuration of the chamber; the inlet aperture is in communication with the outlet aperture; the at least partial occlusion elements brings the container in communication with the vent apertures.

The present invention refers to a dispensing system with closed loop, simple and inexpensive to manufacture, configured to be connected to a container containing a liquid and to an external suction device that allows to selectively dispense the liquid contained in the container in a simple, reliable, efficient way, safely for the operator and substantially without contaminating the liquid, alternatively permitting the safe closure of the container and the dispensing of even viscous liquids and/or with high volumetric flow rates; the liquid can be a chemical product, the external suction device can be a suction pump, in particular an external dosing pump, or a venturi dosing (or mixer) device, and the container can be of any type, for instance, a bag or a canister.

Moreover, in the following of the present description reference will be made mainly to applications of the closed loop dispensing system according to the invention to the field of industrial or domestic washing apparatuses, in particular for clothing and/or linen (e.g. industrial washing machines or household appliances), as well as for dishes and/or cookware (e.g. industrial or domestic dishwashers). However, it should be noted that the closed loop dispensing system according to the invention can be applied in any other technological context in which liquids must be used, especially corrosive chemical liquids, or in any case liquids aggressive and dangerous for the operators' health, contained in containers, as for example in the field of water treatment, in the field of laboratory analysis (e.g. for diagnostic purposes) and in the field of manufacturing of metal, plastic and semiconductor devices, still remaining within the scope of the present invention as defined by the attached claims.

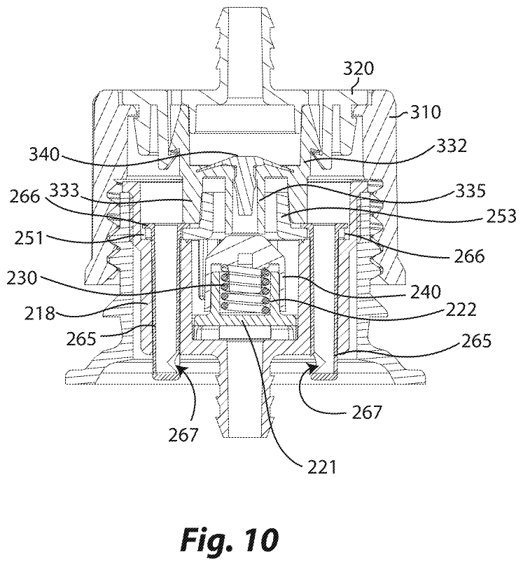

Furthermore, in the following of the present description, reference will be mainly made to applications in which the closed loop dispenser system according to the invention is connected to an external suction pump. However, it should be noted that the closed loop dispenser system according to the invention can be connected to a different external suction device, such as for example an external venturi dosing (or mixer) device (similar to the one shown in FIG. 10 of document WO 2013/011484 A1), still remaining within the scope of the present invention as defined by the attached claims.

It is known that in the field of washing apparatuses it is often necessary for a metering pump to suck a liquid chemical product from a container, such as a bag or a canister, in order to mix it with water according to a precise dosage. Often, the liquid chemical product is corrosive, or in any case aggressive and dangerous for the operators' health, and it is contained in a container such as a bag or a canister.

To ensure the safety of the operators, it is necessary that the dispensing of the liquid chemical product contained in the container is selectively allowed only under operating conditions, i.e. only when the container is connected to an external dosing pump, preventing the chemical product liquid from exiting the container under non-operating conditions, i.e. when the container is not connected to a dosing pump. In particular, under non-operating conditions, potentially dangerous situations can occur for the operators, such as in the case where the container falls or topples over without being connected to an external dosing pump.

To this end, the container is usually provided with a closed-circuit dispenser system, comprising a base integrally coupled to the aperture of the container itself and a dispenser cap removably connectable to the base (e.g. that can be screwed onto a threaded crown of the base). The base is usually connected (or integrally coupled) to a dip tube extending therefrom towards the inside of the container to extract the liquid. The dispenser cap is provided with a dispensing tube (possibly integrally coupled thereto) that allows to connect the dispenser cap, and consequently the container when this is connected to the base, to the external dosing pump.

The base is provided with a mechanical valve device that is normally substantially closed, whereby the liquid cannot exit the container, and that is opened when the dispenser cap is connected to the base (e.g. through the interaction of an element of the dispenser cap that moves a movable element of the mechanical valve device, whereby the liquid can exit the container.

In some prior art closed-circuit dispensing systems, the base is further provided with vent valves allowing air to pass towards the inside of the container under operating conditions during liquid suction.

Only for a minority of the prior art closed-circuit dispensing systems the base is provided with vent devices which also allow degassing, i.e. the exit of the gas that forms inside the container therefrom, even under non-operating conditions.

Such a prior art closed-circuit dispensing system is disclosed in document U.S. Pat. No. 6,142,345 A. Other prior art closed-circuit dispensing systems are disclosed in documents U.S. Pat. No. 5,988,456, US 2003/00150887 A1, US 2004/00206786 A1, US 2004/0164104 A1, US 2005/0045666 A1, EP 1512638 A2, US 2006/283896 A1, US 2010/00213220 A1, US 2010/0258593 A1 and U.S. Pat. No. 9,242,847 B1.

However, prior art closed loop dispensing systems suffers from some drawbacks.

For example, the closed circuit dispensing system disclosed in US 6142345 A comprises a mechanical valve device that, under operating conditions, allows the liquid to pass only through a small hole, whereby only a reduced volumetric flow rate is allowed during liquid suction, and furthermore the system is unsuitable for containers containing viscous liquids.

Furthermore, the components of the closed circuit dispensing system disclosed in U.S. Pat. No. 6,142,345 A are very complex to manufacture, entailing high costs.

Other prior art closed circuit dispensing systems suffer from the same drawbacks, and additionally they may suffer from further disadvantages, such as for instance a poor or absent degassing, an unsuitability for containers containing aggressive chemical liquids which could dissolve metallic and/or elastomeric materials of some system components, e.g. springs and 0-ring seals, thus contaminating at the same time the liquid during suction.

Therefore, it is an object of the present invention to allow in a simple, reliable, efficient, inexpensive way, and safely for the operator, to selectively dispense a liquid, in particular a liquid chemical product, contained in any container (e.g. a bag or a canister), from which the liquid can be sucked by an external suction device (e.g. a suction pump, in particular an external dosing pump, or a venturi dosing or mixer device) alternatively permitting the safe closure of the container and the dispensing of even viscous liquids and/or with high volumetric flow rates.

It is specific subject matter of the present invention a closed loop dispensing system comprising a mechanical valve device, configured to be inserted into a receiver integrally coupled to a container in correspondence with an access aperture thereof, and a dispenser cap configured to be coupled to the receiver, wherein
the mechanical valve device has a longitudinal axis and comprises
   a cup-shaped base configured to be inserted into the receiver and closed by a bottom having an inlet aperture configured to be inserted into the container, when the mechanical valve device is inserted into the receiver, the cup-shaped base being provided with one or more longitudinal tunnels which house respective one or more at least partial occlusion elements,
   a spring support, that is coupled to the cup-shaped base and that is spaced apart from the bottom of the cup-shaped base, wherein the spring support is provided with a spring support top sleeve, the spring support being configured to put the inlet aperture in fluid communication with an outer surface of the spring support top sleeve,
   a movable sealing dome slidingly coupled to the spring support top sleeve ensuring a seal between the movable sealing dome and the spring support top sleeve, whereby the spring support top sleeve and the movable sealing dome define a variable volume sealed chamber that houses an elastic element supported by the cup-shaped base, wherein the elastic element assumes an elongated configuration when said chamber assumes an enlarged configuration having a first volume and a compressed configuration when said chamber assumes a reduced configuration having a second volume lower than the first volume, and
   a locking cover resting on the cup-shaped base and having a locking cover top sleeve surrounding a hole, wherein an edge of the hole and the movable sealing dome are configured to be in contact with each other by sealed interference fit when the elastic element assumes the elongated configuration,
and wherein the dispenser cap, having an outlet aperture and one or more vent apertures, comprises an unlocking member having a bottom cylinder and a bottom central duct that is arranged inside the bottom cylinder and is in fluid communication with the outlet aperture,
wherein, when the mechanical valve device is inserted into the receiver and the dispenser cap is decoupled from the receiver, said chamber assumes the enlarged configuration and the inlet aperture is in fluid communication with the cup-shaped base up to a bottom surface of the locking cover with the hole closed by the interference seal between the edge of the hole and the movable sealing dome, and
wherein, when the mechanical valve device is inserted into the receiver and the dispenser cap is coupled to the receiver, the bottom cylinder is coupled by interference fit to the locking cover top sleeve and the bottom central duct interacts with the movable sealing dome causing said chamber to assume the reduced configuration, whereby the inlet aperture is in fluid communication with the outlet aperture, and said one or more at least partial occlusion elements are configured to cause the container to be in fluid communication with said one or more vent apertures.

According to another aspect of the invention, said one or more at least partial occlusion elements can be one or more labyrinth inserts inserted into said one or more longitudinal tunnels and configured to stably remain therein thanks to an interference fit between an outer surface of each labyrinth insert and an inner surface of the respective longitudinal tunnel, said one or more labyrinth inserts being configured to partially occlude said one or more longitudinal tunnels and to make a labyrinth seal.

According to a further aspect of the invention, when the mechanical valve device is inserted into the receiver and the dispenser cap is decoupled from the receiver, said one or more at least partial occlusion elements can be configured to seal said one or more longitudinal tunnels, whereby the container is not in fluid communication with said one or more vent apertures.

According to an additional aspect of the invention, when the mechanical valve device is inserted into the receiver, after the dispenser cap has been coupled to the receiver for a first time, said one or more at least partial occlusion elements can be configured to cause the container to remain in fluid communication with said one or more vent apertures when the dispenser cap is removed from the receiver.

According to another aspect of the invention, said one or more longitudinal tunnels can be one or more longitudinal hollow cylinders and said one or more at least partial occlusion elements can be one or more hollow cylinders inserted into said one or more longitudinal hollow cylinders, respectively, wherein each one of said one or more hollow cylinders is configured to stably remain in the respective longitudinal hollow cylinder, in absence of external forces exerted on said one or more hollow cylinders, thanks to an interference fit between an outer surface of each one or more at least partial occlusion hollow cylinder and an inner surface of the respective longitudinal hollow cylinder, each one of said one or more hollow cylinders being provided with a bottom aperture, wherein, when the mechanical valve device is inserted into the receiver and the dispenser cap is coupled to the receiver, the bottom aperture of each one of said one or more hollow cylinders is in fluid communication with the container.

According to a further aspect of the invention, each one of said one or more hollow cylinders can be provided with a top flange, wherein, when the mechanical valve device is inserted into the receiver and the dispenser cap is decoupled from the receiver, said one or more hollow cylinders can be inserted into said one or more longitudinal hollow cylinders with a top end protruding from a top surface of the locking cover, whereby the top flange of each one of said one or more hollow cylinders is spaced apart from the locking cover, and wherein, when the mechanical valve device is inserted into the receiver and the dispenser cap is coupled to the receiver, the bottom cylinder of the unlocking member interacts with the top flange of each one of said one or more hollow cylinders pushing them towards the locking cover and causing a bottom end of said one or more hollow cylinders to protrude from the bottom of the cup-shaped base.

According to an additional aspect of the invention, each one of said one or more hollow cylinders can be provided with an elastic return device interposed between the top surface of the locking cover and the top flange that is configured to interact with the top flange and to cause, when the mechanical valve device is inserted into the receiver and the dispenser cap is decoupled from the receiver, the top end of the respective hollow cylinder to protrude from the top surface of the locking cover.

According to another aspect of the invention, said one or more longitudinal tunnels can be one or more longitudinal hollow cylinders, each one of which has a longitudinal cavity, and each one of said one or more at least partial occlusion elements comprises a cylinder having a grooved side wall comprising at least one groove, wherein the cylinder ends with a solid cylindrical bottom head, wherein said one or more at least partial occlusion elements are inserted in said one or more longitudinal hollow cylinders, respectively, wherein each one of said one or more at least partial occlusion elements is configured to stably remain in the respective longitudinal hollow cylinder, in absence of external forces exerted on said one or more at least partial occlusion elements, thanks to an interference fit between an outer surface of the solid cylindrical bottom head of each one of said one or more occlusion elements and an inner surface of the respective longitudinal hollow cylinder, wherein, when the mechanical valve device is inserted into the receiver and the dispenser cap is coupled to the receiver, the solid cylindrical bottom head of each one of said one or more at least partial occlusion elements projects and is spaced apart from the longitudinal cavity of the respective longitudinal hollow cylinder, whereby the longitudinal cavity of each one of said one or more longitudinal hollow cylinders is in fluid communication, through said at least one groove on the grooved side wall of the cylinder of each one of said one or more at least partial occlusion elements, with the container.

According to a further aspect of the invention, each one of said one or more at least partial occlusion elements can be provided with a perforated top flange, wherein, when the mechanical valve device is inserted into the receiver and the dispenser cap is decoupled from the receiver, said one or more at least partial occlusion elements are inserted into said one or more longitudinal hollow cylinders with a top end protruding from a top surface of the locking cover, whereby the perforated top flange of each one of said one or more at least partial occlusion elements is spaced apart from the locking cover, and wherein, when the mechanical valve device is inserted into the receiver and the dispenser cap is coupled to the receiver, the bottom cylinder of the unlocking element interacts with the perforated top flange of each one of said one or more at least partial occlusion elements pushing it towards the locking cover and causing the solid cylindrical bottom head of each one of said one or more at least partial occlusion elements to project and to be spaced apart from the longitudinal cavity of the respective longitudinal hollow cylinder, whereby the longitudinal cavity of each one of said one or more longitudinal hollow cylinders is in fluid communication, through said at least one groove on the grooved side wall of the cylinder of each one of said one or more at least partial occlusion elements, with the container and, through holes of the perforated flange, with said one or more vent apertures.

According to an additional aspect of the invention, each one of said one or more at least partial occlusion elements is provided with an elastic return device interposed between the top surface of the locking cover and the perforated top flange that is configured to interact with the perforated top flange and to cause, when the mechanical valve device is inserted into the receiver and the dispenser cap is decoupled from the receiver, the top end of the respective at least partial occlusion element to project from the top surface of the locking cover.

According to another aspect of the invention, the locking cover can be attached to the cup-shaped base through ultrasonic welding.

According to a further aspect of the invention,
the cup-shaped base can have a substantially cylindrical body closed by the bottom that is provided with a hollow support protruding outward from the bottom, whereby a cavity of the hollow support acts as inlet aperture of the bottom, wherein a top of the body of the cup-shaped base is open and provided with a substantially cylindrical collar having diameter greater than that of the body and provided with a ring-shaped top flange extending outward, the collar joining with the body through a ring-shaped ledge, wherein the collar is configured to be slidingly coupled by interference fit to the receiver when the mechanical valve device is inserted into the receiver until the top flange abuts an inlet edge of the receiver, the body comprising said one or more longitudinal tunnels extending between the bottom and the ring-shaped ledge,
wherein the spring support can have a plate from which the spring support top sleeve protrudes, an outline of the plate having one or more portions corresponding to outer surfaces of said one or more longitudinal tunnels directed internally to the body and being provided with one or more notches configured to put the inlet aperture in fluid communication with an outer surface of the spring support top sleeve,
wherein the movable sealing dome can have a substantially cylindrical body and a top end closed by a frustoconical lateral surface and by an apical disc,
wherein the locking cover can comprise a substantially circular disc provided with the hole having a circumference corresponding to an inner cylindrical surface of the collar, whereby the disc is configured to rest on the ring-shaped ledge, the disc being provided with one or more recesses configured to overlap said one or more longitudinal tunnels, wherein the edge of the hole of the disc and the frustoconical lateral surface of the movable sealing dome are configured to be in contact by sealed interference fit with each other when the elastic element assumes the elongated configuration,
wherein the dispenser cap can comprise a substantially circular locking ferrule, having a bottom aperture and a top aperture, and a covering cap coupled by snap-fit to the ferrule in correspondence to the top aperture and that is provided with said one or more vent apertures and with a hollow support, that protrudes outward from a top surface of the covering cap, whereby a cavity of the hollow support acts as outlet aperture of the dispenser cap,
wherein the unlocking member can include a perforated plate from which a top cylinder and the bottom cylinder protrude in opposite directions, the covering cap being coupled by snap-fit to the top cylinder.

According to an additional aspect of the invention, the dispenser cap can further comprise a flexible umbrella valve having a stem housed in the bottom central duct.

It is also specific subject matter of the present invention a kit of components for making a closed loop dispensing system as previously described, comprising:
a cup-shaped base configured to be inserted into the receiver and closed by a bottom having an inlet aperture, the cup-shaped base being provided with one or more longitudinal tunnels;
one or more at least partial occlusion elements configured to be housed in said one or more longitudinal tunnels, respectively,
a spring support, configured to be coupled to the cup-shaped base and to be spaced apart from the bottom of the cup-shaped base, wherein the spring support is provided with a spring support top sleeve, the spring support being configured to put the inlet aperture in fluid communication with an outer surface of the spring support top sleeve,
a movable sealing dome configured to be slidingly coupled to the spring support top sleeve ensuring a seal between the movable sealing dome and the spring support top sleeve,
an elastic element configured to be housed in a variable volume sealed chamber defined by the spring support top sleeve and the movable sealing dome and to be supported by the cup-shaped base,
a locking cover configured to be resting on the cup-shaped base and having a locking cover top sleeve surrounding a hole, wherein an edge of the hole and the movable sealing dome are configured to be in contact with each other by sealed interference fit, and
a dispenser cap, having an outlet aperture and one or more vent apertures, and comprising an unlocking member having a bottom cylinder and a bottom central duct that is arranged inside the bottom cylinder and configured to be in fluid communication with the outlet aperture.

The advantages offered by the closed loop dispensing system according to the invention are evident, since it solves all the aforementioned problems of the prior art systems.

First of all, the closed loop dispensing system according to the invention has a large section for liquid passage and an efficient vent circuit, that allows dispensing of even viscous liquids and/or with high volumetric flow rates, permitting both the passage of an adequate amount of air towards the inside of the container during suction and, at least for some embodiments, the degassing when the closed circuit dispensing system is closed.

Moreover, the compression spring, or a similar elastic compression element, advantageously made of metal, is protected inside a sealed chamber (having variable volume) which prevents the spring from coming into contact with the liquid of the container when the liquid is sucked from the outside.

Furthermore, the components of the closed circuit dispensing system according to the invention are easy to manufacture and to assemble, thus reducing the related costs.

The present invention will be now described, by way of illustration and not by way of limitation, according to its preferred embodiments, by particularly referring to the Figures of the annexed drawings, in which:

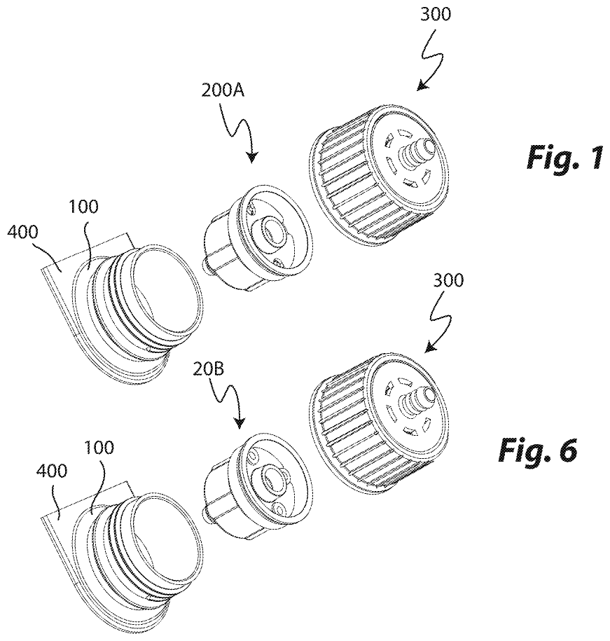

FIG. 1 shows a top perspective view of a first embodiment of the closed loop dispensing system according to the invention;

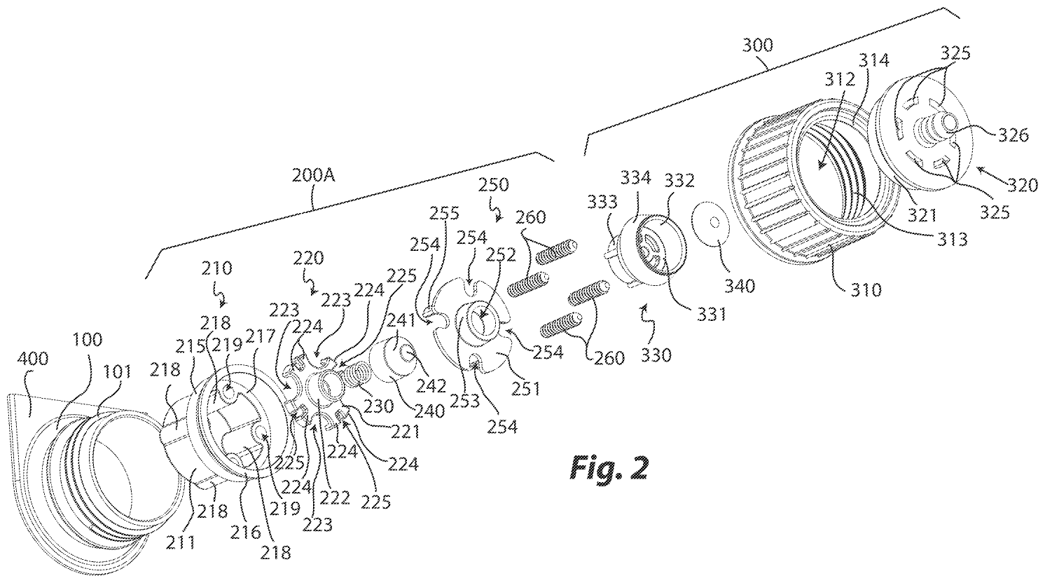

FIG. 2 shows an exploded top perspective view of the closed loop dispensing system of FIG. 1;

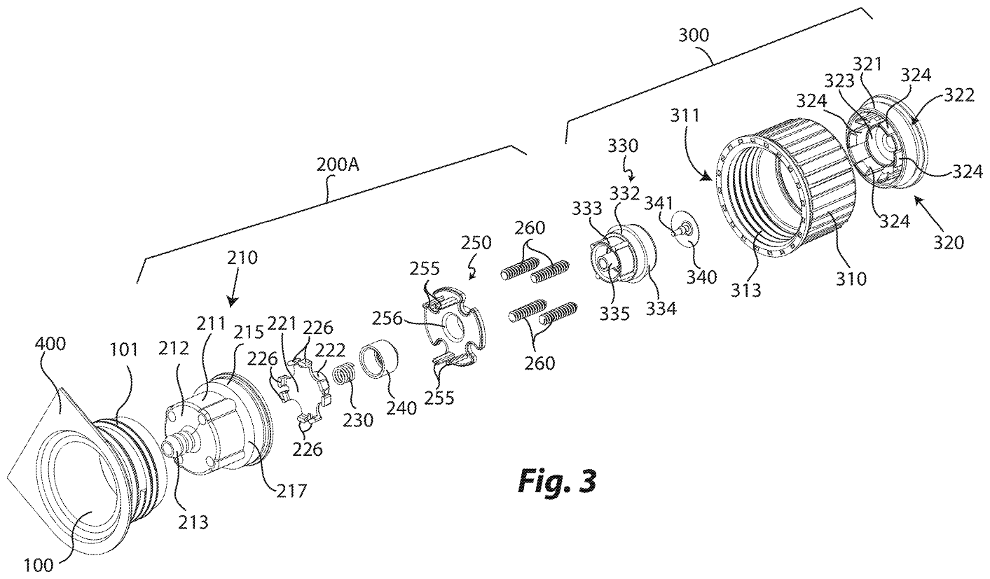

FIG. 3 shows an exploded bottom perspective view of the closed loop dispensing system of FIG. 1;

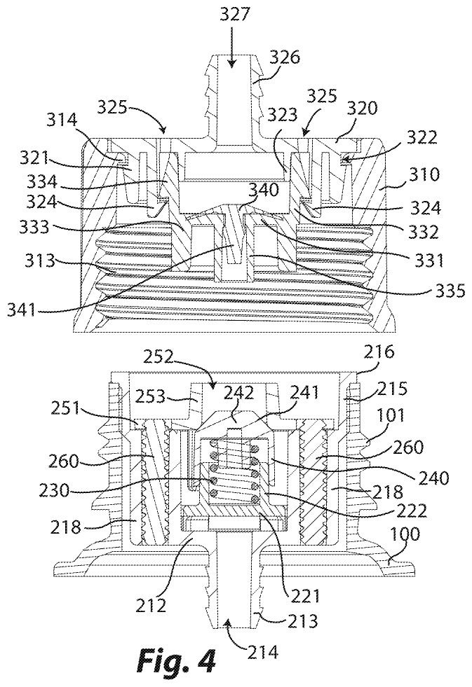

FIG. 4 shows a longitudinal section view of the closed loop dispensing system of FIG. 1 in a first configuration;

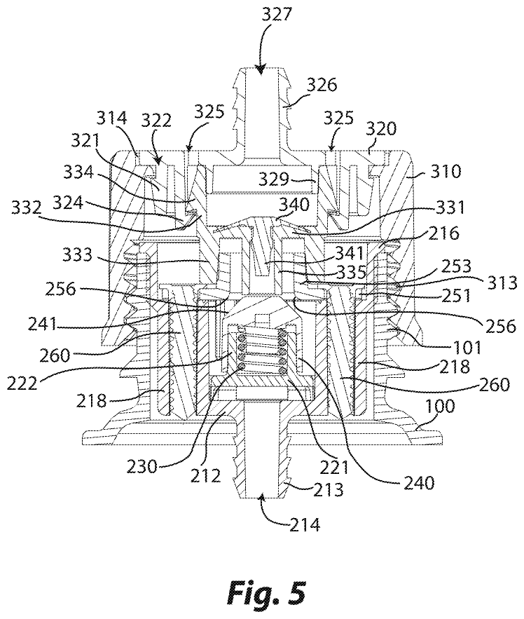

FIG. 5 shows a longitudinal section view of the closed loop dispensing system of FIG. 1 in a second configuration;

FIG. 6 shows a top perspective view of a second embodiment of the closed loop dispensing system according to the invention;

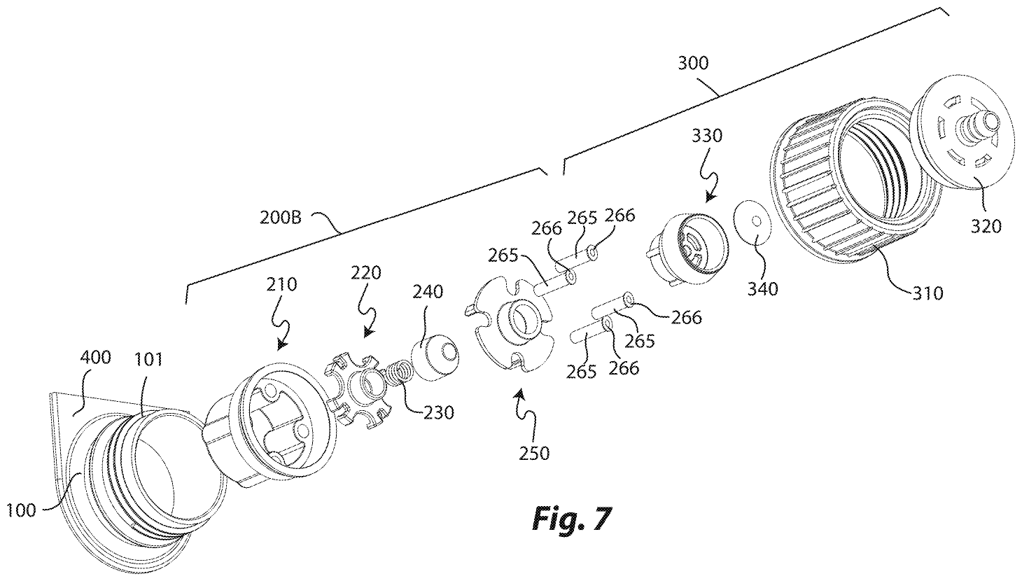

FIG. 7 shows an exploded top perspective view of the closed loop dispensing system of FIG. 6;

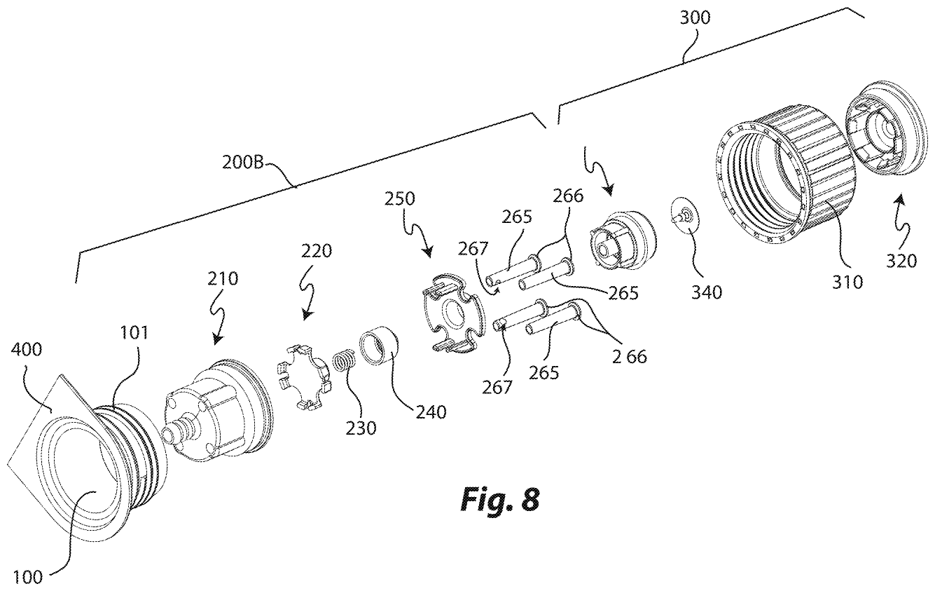

FIG. 8 shows an exploded bottom perspective view of the closed loop dispensing system of FIG. 6;

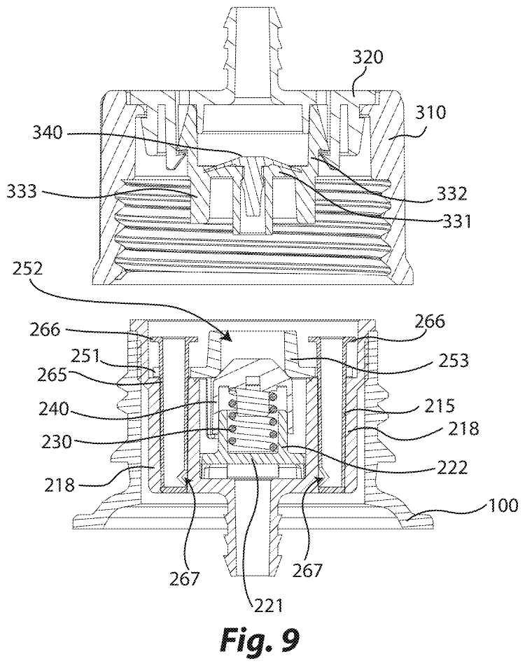

FIG. 9 shows a longitudinal section view of the closed loop dispensing system of FIG. 6 in a first configuration; and

FIG. 10 shows a longitudinal section view of the closed loop dispensing system of FIG. 6 in a second configuration.

In the Figures, identical reference numerals will be used for alike elements.

In the following of the description, directional terminology, such as “front”, “rear”, “upper”, “lower”, “side”, etc., is used with reference to the Figures of the attached drawings. Since components and/or elements and/or embodiments of the present invention may be positioned and/or caused to operate in various different orientations, directional terminology is merely used by way of example and not by way of limitation.

With reference to FIGS. 1-5, it may be observed that a first embodiment of the closed loop dispensing system according to the invention comprises a mechanical valve device 200A, configured to be inserted into a receiver 100 integrally coupled to a container 400 (partially shown in FIGS. 1 and 2) in correspondence with an access aperture thereof, and a dispenser cap 300 configured to be coupled, optionally removably, to the receiver 100 having substantially cylindrical shape.

The mechanical valve device 200A comprises a cup-shaped base 210 to which a spring support 220 is configured to be coupled, acting as base supporting a compression spring 230, advantageously a metallic spring.

The cup-shaped base 210 has a substantially cylindrical body 211 inferiorly closed by a bottom 212 provided with a hollow support 213 protruding outwards from the bottom 212; the hollow support 213, the internal cavity 214 of which is cylindrical (even if this is not an essential feature for the invention), is configured to be inserted into an end of a conventional dip tube (not shown in the Figures), optionally flexible, and advantageously extending towards the inside of the container to extract the liquid therefrom when the mechanical valve device 200A is connected to the receiver 100. The top (i.e. the end opposite to the bottom 212) of the body 211 of the cup-shaped base 210 is open and is provided with a substantially cylindrical collar 215 having diameter greater than that of the body 211; in particular, the collar 215, that is provided with a ring-shaped top flange 216 extending outwards, joins the body 211 through a ring-shaped ledge 217. When the mechanical valve device 200A is inserted into the receiver 100, the collar 215 slidingly couples by interference fit to the receiver 100 until the top flange 216 abuts the edge of the inlet of the receiver 100; in particular, the collar 215 is configured to slide on the inner surface of the receiver 100, as shown in FIGS. 4 and 5; advantageously, the mechanical valve device 200A is removably insertable into the receiver 100, but it must be noted that the mechanical valve device 200A can be inserted into the receiver 100 and integrally coupled thereto, e.g. through ultrasonic welding. The body 211 further comprises four longitudinal hollow cylinders 218 extending between the bottom 212 and the ring-shaped ledge 217, angularly evenly distributed around a longitudinal axis of the body 211 (even if the angularly even distribution of the longitudinal hollow cylinders 218 is not an essential feature of the invention); in particular, the longitudinal axis of the body 211 coincides with the longitudinal axis of the mechanical valve device 200A. Namely, the outer diameter of the longitudinal hollow cylinders 218 is larger than the radial width of the ring-shaped ledge 217 and the longitudinal hollow cylinders 218 slightly protrude from the outer surface of the body 211, even if these are not essential features of the invention.

The spring support 220 has a plate 221 substantially planar (even if the planarity of the plate 221 is not an essential feature of the invention) from the top surface of which a sleeve 222 protrudes that has a longitudinal axis orthogonal to the plate 221 passing through the centroid of the plate 221 itself (even if the position of the longitudinal axis of the sleeve 222 is not an essential feature of the invention). The outline of the plate 221 comprises four arcs 223 of circumference each one corresponding, apart from usual dimensional tolerances, to the outer cylindrical surface of a respective hollow cylinder 218 directed towards the inside of the body 211 of the cup-shaped base 210. Between each pair of arcs 223 of circumference consecutive to each other, the outline of the plate 221 comprises a pair of tabs 224 delimiting a notch 225 interposed between them; in correspondence with each one of the eight tabs 224, the outline of the plate 221 defines a respective arc of circumference corresponding, apart from usual dimensional tolerances, to the inner cylindrical surface of the body 211. Respective spacer feet 226 protrude from each one of the tabs 224 in direction opposite to the one along which the sleeve 222 protrudes; in other words, eight spacer feet 226 protrude in correspondence with the eight tabs 224, respectively, from the bottom surface of the plate 221 (opposite to the top surface from which the sleeve 222 protrudes), configured to be facing the bottom 212 of the cup-shaped base 210. The eight spacer feet 226 are configured to rest onto the bottom 212 and to space apart the plate 221 from the bottom 212 itself (as shown in FIGS. 4 and 5).

In general, the spring support (220) of the closed loop dispensing system according to the invention has a (not necessarily planar) plate (221) that is provided with a top sleeve (222) protruding from the top surface of the plate (221), wherein the plate (221) is spaced apart from the bottom (212) of the cup-shaped base (210).

The mechanical valve device 200A still comprises a movable sealing dome 240 having a substantially cylindrical body, the base end of which is open, and the top end of which is closed by a truncated cone having a frustoconical lateral surface 241 and a substantially planar apical disc 242. The substantially cylindrical body of the movable sealing dome 240 is configured to slidingly couple to the sleeve 222 ensuring a sealed interference fit between the movable sealing dome 240 and the sleeve 222. Consequently, when they are slidingly coupled as shown in FIGS. 4 and 5, the sleeve 222 and the movable sealing dome 240 define a variable volume sealed chamber housing the compression spring 230. In particular, the substantially cylindrical body of the movable sealing dome 240 is configured to slide on the outer surface of the sleeve 222. Namely, the spring assumes an elongated configuration, when the chamber defined by the sleeve 222 and the movable sealing dome 240 assumes an enlarged configuration having a first volume (see FIG. 4) and a compressed configuration when such chamber assumes a reduced configuration having a second volume lower than the first volume (see FIG. 5).

Also, the mechanical valve device 200A comprises a locking cover 250 having a substantially planar disc 251 (even if the planarity of the disc 251 is not an essential feature of the invention) provided with a central circular hole 252. A sleeve 253 surrounding the hole 252 protrudes from the top surface of the disc 251, whereby the sleeve 253 has a longitudinal axis orthogonal to the disc 251 and passing through the centre thereof (even if the position of the hole 252 and the corresponding position of the sleeve 253 surrounding it are not essential features of the invention). The circumference of the disc 251 corresponds, apart from usual dimensional tolerances, to the inner cylindrical surface of the collar 215 of the cup-shaped base 210, whereby the disc 251 is configured to rest onto the ring-shaped ledge 217 joining the collar 215 and the body 211. The disc 251 is provided with four recesses 254 configured to overlap the apertures 219 of the four longitudinal hollow cylinders 218, respectively, arranged on the ring-shaped ledge 217. Two pairs of positioning pins 255 protrude from the bottom surface of the disc 251 (opposite to the top surface from which the sleeve 253 protrudes), configured to be facing the ring-shaped ledge 217 (and the bottom 212 of the cup-shaped base 210), each pair being configured to interact with a respective pair of outer cylindrical surfaces of two longitudinal hollow cylinders 218 consecutive to each other. In particular, when the locking cover 250 is inserted into the cup-shaped base 210, the two pairs of positioning pins 255 position the four recesses 254 of the disc 251 so as to overlap (i.e. da be in correspondence of) the apertures 219 of the four longitudinal hollow cylinders 218, respectively, arranged on the ring-shaped ledge 217, whereby such apertures 219 remain free (i.e. not closed by the disc 251), as shown in FIGS. 4 and 5. When the locking cover 250 is inserted into the cup-shaped base 210, the longitudinal axis of the hole 252 coincides with the longitudinal axis of the movable sealing dome 240. The edge 256 of the hole 252 and the frustoconical lateral surface 241 of the movable sealing dome 240 are configured to ensure a sealed interference fit when they are in contact with each other under the exertion of the compression spring 230 (i.e. when the spring 230 assumes the elongated configuration), as shown in FIG. 4; in other words, if no external force is exerted on the apical disc 242 of the movable sealing dome 240 to produce a compression of the spring 230, the compression spring 230 causes the frustoconical lateral surface 241 of the movable sealing dome 240 of the top truncated cone to be in contact with the edge 256 of the hole 252 of the disc 251 of the locking cover 250 closing the mechanical valve device 200A, as shown in FIG. 4.

Furthermore, the mechanical valve device 200A comprises four labyrinth inserts 260 configured to be inserted into the longitudinal cavities defined by the four longitudinal hollow cylinders 218, respectively, as shown in FIGS. 4 and 5, and to stably remain thanks to the interference between their outer surface and the inner surface of the respective longitudinal hollow cylinders 218. In particular, each one of the four labyrinth inserts 260 is configured to partially occlude the longitudinal cavity defined by the respective longitudinal hollow cylinder 218 and to make a labyrinth seal, whereby the four threaded inserts 260, when inserted into the four longitudinal hollow cylinders 218, offer (at least) one tortuous path allowing gaseous fluids to pass and hindering the passage of liquids, thus hindering the leakage of a liquid contained in a container 400 when the mechanical valve device 200A is connected to the receiver 100 integrally coupled to the container 400.

The dispenser cap 300 comprises a locking ferrule 310 substantially cylindrical, having a bottom aperture 311 and a top aperture 312 and a covering cap 320, having a cylindrical wall 321 protruding from the bottom surface (configured to be facing the mechanical valve device 200A when the covering cap 320 is secured to the locking ferrule 310 in correspondence of the top aperture 312 and the dispenser cap 300 is coupled to the receiver 100) of the covering cap 320 itself. The locking ferrule 310 is internally provided with a thread 313 so as to be configured to be removably screwed on a corresponding thread 101 of the receiver 100 integrally coupled to the container 400. The covering cap 320 is configured to be secured to the locking ferrule 310 through a snap-fit coupling, thanks to the insertion of a circular ridge 314, arranged on the inner surface of the locking ferrule 310 in correspondence of the top aperture 312, in a corresponding notch 322 of the cylindrical wall 321, as shown in FIGS. 4 and 5; in this way, when the covering cap 320 is secured to the locking ferrule 310, the covering cap 320 itself can freely rotate with respect to the locking ferrule 310, allowing the container 400 to be more easily handled during its use.

A sleeve 323 protrudes from the bottom surface of the covering cap 320; such sleeve 323 is concentrically arranged internally to the cylindrical wall 321 and has a longitudinal axis orthogonal to the substantially planar top surface of the covering cap 320 (even if the planarity of the top surface is not an essential feature of the invention) and passing through the centroid of the covering cap 320 itself (even if the position of the longitudinal axis of the sleeve 323 is not an essential feature of the invention). Also, a plurality of snap-fit coupling wings 324 arranged along a circumference interposed between the cylindrical wall 321 and the sleeve 323 protrude from the bottom surface of the covering cap 320, optionally angularly evenly distributed around the longitudinal axis of the sleeve 323 (even if the angularly even distribution of the coupling wings 324 is not an essential feature of the invention).

The covering cap 320 is provided with a plurality of vent apertures 325 arranged along a circumference interposed between the snap-fit coupling wings 324 and the sleeve 323; in the first embodiment of the closed loop dispensing system according to the invention the number of vent apertures 325 is equal to the number of coupling wings 324, namely it is equal to six, and the vent apertures 325 are arranged in correspondence with respective coupling wings 324.

The covering cap 320 is further provided with a hollow support 326 protruding externally from the top surface of the covering cap 320 (opposite to the bottom surface thereof); the hollow support 326, the internal cavity 327 of which is cylindrical (even if this is not an essential feature for the invention), is configured to be inserted into an end of a conventional dispensing tube (not shown in the Figures), optionally flexible, that allows to connect the dispenser cap 300 to an external dosing pump. The internal cavity 327 of the hollow support 326 is separated from the vent apertures 325.

The dispenser cap 300 also comprises an unlocking member 330 including a perforated plate 331 from which a top cylinder 332 and a bottom cylinder 333 protrude in opposite directions. The top cylinder 332 is configured to slidingly couple by interference fit to the sleeve 323 of the covering cap 320; in particular, the top cylinder 332 of the unlocking member 330 is configured to slide on the outer surface of the sleeve 323 of the covering cap 320. Also, to increase the stability of the coupling of the top cylinder 332 of the unlocking member 330 to the covering cap 320, the top cylinder 332 of the unlocking member 330 is configured to be secured to the covering cap 320 also through a snap-fit coupling (even if this is not an essential feature for the invention), thanks to the interaction of an end wing 334 of the top cylinder 332 with the plurality of snap-fit coupling wings 324, as shown in FIGS. 4 and 5. The bottom cylinder 333 of the unlocking member 330 is configured to couple by interference fit to the sleeve 253 of the locking cover when the dispenser cap 300 is coupled to the receiver 100 (by screwing the locking ferrule 310 onto the thread 101 of the receiver 100); in particular, when the locking ferrule 310 is screwed onto the thread 101 of the receiver 100, the bottom cylinder 333 of the unlocking member 330 is configured to slide on the outer surface of the sleeve 253 of the locking cover.

The dispenser cap 300 further comprises a flexible umbrella valve 340, the stem 341 of which is configured to be housed in a bottom central duct 335 protruding from the perforated plate 331 inside the bottom cylinder 333. The bottom end of the bottom central duct 335 is configured to interact with the apical disc 242 of the movable sealing dome 240 when the dispenser cap 300 is coupled to the receiver 100, as shown in FIG. 5. The umbrella valve (that is not an essential feature for the invention) is configured to prevent the backflow from the dispensing tube (connected to the hollow support 326) to the container 400 during suction.

Advantageously, all the components of the closed loop dispensing system according to the invention which are configured to come into contact with the liquid contained by the container to which the system is applied during suction (i.e. all the components apart from the locking ferrule 310 and compression spring 230) are made of polyethylene, although different polymeric materials, such as polypropylene, can be used. The locking ferrule 310 can be made of a plastic material; the compression spring 230 is advantageously made of metal, even if elastomeric materials can be used as well.

Optionally, the spring support 220 can be secured to the bottom 212 of the cup-shaped base 210 through ultrasonic welding, or it may be removably coupled to the cup-shaped base 210. Similarly, also the locking cover 250 can be attached to the ring-shaped ledge 217 joining the collar 215 to the body 211 of the cup-shaped base 210 through ultrasonic welding, or it may be removably coupled to the ledge 217 of the cup-shaped base 210.

With reference to FIGS. 6-10, a second embodiment of the closed loop dispensing system according to the invention may be observed that differs from the first embodiment of FIGS. 1-5 only in that the mechanical valve device 200B comprises, instead of the four labyrinth inserts 260, four occlusion hollow cylinders 265 configured to be inserted into the longitudinal cavities defined by the four longitudinal hollow cylinders 218, respectively, as shown in FIGS. 9 and 10, and to stably remain, in absence of external forces exerted thereon, thanks to the interference between their outer surface and the inner surface of the respective longitudinal hollow cylinders 218.

Each one of the four occlusion hollow cylinders 265 has a height higher than the height of the respective longitudinal hollow cylinder 218 and it is provided with a top flange 266 and a bottom aperture 267. In particular, when the mechanical valve device 200B is inserted into the receiver 100 before the dispenser cap 300 is coupled to the receiver 100 for the first time (by screwing the locking ferrule 310 onto the thread 101 of the receiver 100), as shown in FIG. 9, each one of the four occlusion hollow cylinders 265 is inserted into the longitudinal cavity defined by the respective longitudinal hollow cylinder 218 with the bottom aperture 267 contained within the longitudinal cavity itself, while the top end portion of the four occlusion hollow cylinders 265 projects from the top surface of the locking cover 250, whereby the top flange 266 is spaced apart from the locking cover 250. In such configuration, each one of the four occlusion hollow cylinders 265 does not allow the passage of liquids, thus preventing a liquid contained in a container 400 from leaking when the mechanical valve device 200A is connected to the receiver 100 integrally coupled to the container 400 and ensuring a tight seal (that also prevents degassing). When the mechanical valve device 200B is inserted into the receiver 100 and the dispenser cap 300 is coupled to the receiver 100 (by screwing the locking ferrule 310 onto the thread 101 of the receiver 100), the bottom cylinder 333 of the unlocking member 330 interacts with the top flanges 266 of the four occlusion hollow cylinders by pushing the top flanges 266 themselves and, consequently, the four occlusion hollow cylinders 265 downwards as shown in FIG. 10, whereby each one of the four occlusion hollow cylinders 265 is inserted into the longitudinal cavity defined by the respective longitudinal hollow cylinder 218 with the top flange 266 resting on the locking cover 250 and with the bottom aperture 267 projecting from the longitudinal cavity itself and that, consequently, it is in communication with the inside of the container 400. In such configuration, each one of the four occlusion hollow cylinders 265 allows large quantities of gaseous fluids to pass, permitting the dispensing of a liquid contained in the container 400 even with high volumetric flow rates without creating any pressure drop within the container 400. In other words, the second embodiment of the closed loop dispensing system according to the invention shown in FIGS. 6-10 acts as a valve that is either entirely closed (as shown in FIG. 9), tightly closing the container 400, or entirely open (as shown in FIG. 10), permitting the dispensing of a liquid contained in the container 400 even with high volumetric flow rates.

It must be noted that other embodiments of the invention can have an arrangement similar to the one of the second embodiment of the closed loop dispensing system according to the invention shown in FIGS. 6-10, from which they differ in the shape of the occlusion hollow cylinders inserted into the longitudinal cavities defined by the four longitudinal hollow cylinders 218, which have a shape configured to allow a partial occlusion, when they are in the configuration of FIG. 9 (e.g. through a specific arrangement of the bottom aperture, that may be always at least partially in fluid communication with the inside of the container 400), whereby such occlusion hollow cylinders allow gaseous fluids to pass and hinder liquids from passing (thus allowing the degassing and hindering the leakage of a liquid contained in a container 400 when the mechanical valve device is connected to the receiver 100 integrally coupled to the container 400), and/or which have a shape configured, when in the configuration of FIG. 10, to hinder (e.g. through a specific arrangement of the bottom aperture, that can be always at least partially occluded by the respective longitudinal hollow cylinder 218) liquids from passing (thus hindering a liquid contained in a container 400 from leaking).

In the following the operating modes of the first and second embodiments of the closed loop dispensing system according to the invention are illustrated, similar modes being valid for other embodiments.

With reference to FIG. 4, it may be observed that, when the dispenser cap 300 is not coupled to the receiver 100 (i.e. when the locking ferrule 310 is not screwed onto the thread 101 of the receiver 100), the compression spring 230 housed in the variable volume chamber defined by the sleeve 222 and the movable sealing dome 240 is in the elongated configuration wherein it causes the frustoconical lateral surface 241 of the movable sealing dome 240 to interact with the edge 256 of the hole 252 of the locking cover 250, ensuring a sealed interference fit between the movable sealing dome 240 and the sleeve 222. As a consequence, the mechanical valve device 200A closes the hole 252 and the inside of the container 400 communicates with the internal cavity 214 of the hollow support 213, in turn communicating with the portion of the cup-shaped base 210 between the bottom 212 and the locking cover 250. In such configuration, each one of the four labyrinth inserts 260 partially occludes the longitudinal cavity defined by the respective longitudinal hollow cylinder 218 and implements a labyrinth seal that, on the one hand, allows gaseous fluids to pass, namely allowing the degassing, from the inside of the container 400 to the vent apertures 325 (by means of the four labyrinth inserts 260 housed in the four longitudinal hollow cylinders 218 putting the inside of the container 400 in fluid communication with the vent apertures 325, creating a path for the gaseous fluids separated from the path that arrives from the internal cavity 214 of the hollow support 213 up to the hole 252 that is closed) and, on the other hand, hinder the liquid from passing from the inside of the container outside of the mechanical valve device 200A, in particular when situations potentially dangerous for the operators occur, such as for instance in the case where the container falls or topples over.

The operation of the second embodiment of the closed loop dispensing system according to the invention, when the dispenser cap 300 has been never coupled for the first time to the receiver 100, is similar, as shown in FIG. 9, with the difference that it ensures a tight seal of the container 400 hindering the degassing.

With reference to FIG. 5, it may be observed that when the dispenser cap 300 is coupled to the receiver 100 (by screwing the locking ferrule 310 onto the thread 101 of the receiver 100), the bottom end of the bottom central duct 335 protruding from the perforated plate 331 of the unlocking member 330 interacts with the apical disc 242 of the movable sealing dome 240, reducing the distance between apical disc 242 and sleeve 222 of the spring support 220 (and, consequently, also reducing the volume of the variable volume chamber defined by the sleeve 222 and the movable sealing dome 240), whereby the compression spring 230 assumes the compressed configuration wherein the frustoconical lateral surface 241 of the movable sealing dome 240 does not interact with the edge 256 of the hole 252 of the locking cover 250. As a consequence, the mechanical valve device 200A opens the container 400 outwards, allowing the liquid that is contained therein to exit (e.g. sucked by an external dosing pump connected to a dispensing tube coupled to the hollow support 326) through the passage formed by: the internal cavity 214 of the hollow support 213, the portion of the cup-shaped base 210 between the bottom 212 and the locking cover 250, the central circular hole 252 of the disc 251 and the sleeve 253 of the locking cover, the bottom cylinder 333 and the top cylinder 332 of the unlocking member 330, the sleeve 323 and the hollow support 326 of the covering cap 320. In particular, the sleeve 253 of the locking cover and the bottom central duct 335 of the unlocking member 330 are configured to put the cup-shaped base 210 in fluid communication with (the bottom cylinder 333 and the top cylinder 332 of) the unlocking member 330 when the bottom end of the bottom central duct 335 pushes the apical disc 242 of the movable sealing dome 240, reducing the distance between apical disc 242 and sleeve 222 of the spring support 220; in particular, the inner diameter of the sleeve 253 of the locking cover is larger than the outer diameter of the bottom central duct 335 of the unlocking member 330 (i.e., the external transverse section of the bottom central duct 335 of the unlocking member 330 is lower than the internal transverse section of the sleeve 253 of the locking cover), whereby it is present a free passage between the inner surface of the sleeve 253 of the locking cover and outer surface of the bottom central duct 335 of the unlocking member 330. In this configuration, each one of the four labyrinth inserts 260 allows gaseous fluids to pass, namely to compensate for the vacuum created inside the container during the suction of the liquid, and it still hinder the liquid from passing from the inside of the container to the outside of the mechanical valve device 200A, in particular when situations potentially dangerous for the operators occur, such as for instance in the case where the container falls or topples over.

The operation of the second embodiment of the closed loop dispensing system according to the invention, when the dispenser cap 300 is coupled to the receiver 100, is similar, as shown in FIG. 10 and previously illustrated, with the difference that it allows large quantities of gaseous fluids to pass, permitting the dispensing of a liquid contained in the container 400 even with high volumetric flow rates without creating any pressure drop within the container 400.

A variant of the second embodiment of the closed loop dispensing system according to the invention is provided with elastic return devices allowing the four occlusion hollow cylinders 265 to return in the configuration shown in FIG. 9 after the dispenser cap 300 is removed from the receiver 100, permitting to use such closed loop dispensing system with higher safety. By way of example, and not by way of limitation, such elastic return devices can be compression springs wrapped around the top end portion of the four occlusion hollow cylinders 265 between the top surface of the disc 251 of the locking cover 250 and the top flanges 266 of the respective occlusion hollow cylinders 265.

It must be noted that in other embodiments of the closed loop dispensing system according to the invention, the longitudinal hollow cylinders 218 can be replaced at least in part with substantially longitudinal tunnels, defining respective longitudinal cavities, having shape different from that of a hollow cylinder, for instance the shape of hollow prism, and that the number of substantially longitudinal tunnels can be one or more, in particular even different from four.

It must be noted that in further embodiments of the closed loop dispensing system according to the invention, the spring support top sleeve 222, that has substantially cylindrical shape, can be replaced with a collar having non-cylindrical shape, e.g. a prism shape; in this case, the body of the movable sealing dome 240 will have a corresponding shape, instead of being substantially cylindrical. Also, even two or more sleeves and/or collars with non-cylindrical shape can protrude from the first surface of the plate 221, each one of which, along with a respective compartment of the movable sealing dome, defines a (variable volume) sealed chamber that houses a respective spring; optionally the two or more sleeves are evenly distributed around the centroid of the plate 221.

It must be noted that in other embodiments of the closed loop dispensing system according to the invention, the spacer feet 226 protruding from the second surface of the plate 221 (opposite to the first surface from which the spring support top sleeve 222 protrudes), that is substantially planar, can be in any number, optionally larger than or equal to two (in this case the spacer feet can have an extended surface resting on the bottom 212), more optionally larger than or equal to three, and they can be also arranged in positions different from those in correspondence of the tabs 224. Also, further embodiments of the closed loop dispensing system according to the invention can be provided with one or more pins protruding from the bottom 212 (and/or also from the inner surface of the cup-shaped base 210) towards the inside of the cup-shaped base 210 and on which the plate 211 rests, which plate in this case can either comprise one or more spacer feet or even be devoid of spacer feet.

It must be noted that in the first and second embodiments of the closed loop dispensing system according to the invention the outline of the plate 221 corresponds, with the exception of the notches 225, to the combination of the outer cylindrical surfaces of the longitudinal hollow cylinders 218 and of the inner cylindrical surface of the body 211 in order to position the longitudinal axis of the spring support top sleeve 222 in correspondence with a longitudinal axis of the cup-shaped base 210, apart from usual dimensional tolerances. However, further embodiments of the closed loop dispensing system according to the invention can have the plate that is not planar and/or that has an outline that does not correspond (not even partially) to the combination of the outer cylindrical surfaces of the longitudinal hollow cylinders 218 and of the inner cylindrical surface of the body 211; in this case, the plate can comprise one or more positioning feet protruding from the second surface of the plate (configured to be facing the bottom 212 of the cup-shaped base 210) and which insert into corresponding notches of the bottom 212 of the cup-shaped base 210 and/or the bottom 212 of the cup-shaped base 210 can comprise one or more positioning pins protruding from the bottom 212 towards the inside of the cup-shaped base 210 and which insert into corresponding notches of the second surface of the plate.

It must be noted that in additional embodiments of the closed loop dispensing system according to the invention, the body of the movable sealing dome 240 can be configured to slide onto the inner surface, instead of the outer surface, of the spring support top sleeve 222 (or more generally of the collar of the spring support).

It must be noted that in other embodiments of the closed loop dispensing system according to the invention, the number of pairs of positioning pins 255 protruding from the second surface of the disc 251 can be an number larger than or equal to one, and that (at least) one pair of positioning pins 255 can interact even with only one outer surface of a hollow cylinder (or more generally of a substantially longitudinal tunnel), and/or (at least) one pair of positioning pins 255 can interact with one pair of outer surfaces of two longitudinal hollow cylinders (or more generally of two substantially longitudinal tunnels) which are not necessarily consecutive to each other.

It must be noted that in further embodiments of the closed loop dispensing system according to the invention, the labyrinth inserts 260 and/or the occlusion hollow cylinders 265 can be replaced with other at least partial occlusion elements, such as threaded inserts or solid cylinders with surface provided with ribs, configured to offer one or more passages to gaseous fluids and to hinder the passage of liquids, so as to hinder the leakage of a liquid contained in a container when the mechanical valve device of the closed loop dispensing system is connected to a receiver integrally coupled to the container, or configured to ensure a tight seal when the mechanical valve device of the closed loop dispensing system is connected to a receiver integrally coupled to the container and the locking ferrule 310 is not screwed onto the thread 101 of the receiver 100, and to allow large quantities of gaseous fluids to pass when the mechanical valve device of the closed loop dispensing system is connected to a receiver integrally coupled to the container and the locking ferrule 310 is screwed onto the thread 101 of the receiver 100, permitting the dispensing of a liquid contained in the container 400 even with high volumetric flow rates without creating any pressure drop inside the container 400.

By way of example, and not by way of limitation, each one of the at least partial occlusion elements can comprise a cylinder having a grooved side wall comprising at least one helicoidal groove (or even at least one curvilinear or linear groove), wherein the cylinder ends with a solid cylindrical bottom head, whereby said at least one groove is configured to offer a path to the gases from the top surface of the solid cylindrical bottom head to the top end of the cylinder (more generally, the cylinder has a grooved side wall comprising at least one groove configured to offer such path to the gases), wherein such at least partial occlusion elements are configured to be inserted into the longitudinal cavities defined by four longitudinal hollow cylinders (similar to those indicated with the reference numeral 218 in FIGS. 2-5 and 7-10). Each one of such at least partial occlusion elements has a height higher than the height of the respective longitudinal hollow cylinder (218) and it is advantageously provided with a perforated top flange (similarly to the occlusion hollow cylinders 265 shown in FIGS. 7-10), even if such perforated flange is not an essential feature for the invention. When the mechanical valve device is inserted into the receiver 100 before the dispenser cap (similar to the one indicated with the reference numeral 300 in FIGS. 7-10) is coupled for the first time to the receiver 100, each one of such at least partial occlusion elements is inserted into the longitudinal cavity defined by the respective longitudinal hollow cylinder (218) with the solid cylindrical bottom head contained within the longitudinal cavity itself, while the top end portion projects from the top surface of the locking cover (similar to the one indicated with the reference numeral 250 in FIGS. 7-10), whereby the perforated top flange (266) is spaced apart from the locking cover (250). In such configuration, the lateral surface of the solid cylindrical bottom head of each one of such at least partial occlusion elements and the inner surface of the longitudinal cavity defined by the respective longitudinal hollow cylinder (218) are in contact with each other and ensure a sealed interference fit, whereby they do not allow any passage of liquids, thus hindering leakage of a liquid contained in a container 400 when the mechanical valve device is connected to the receiver 100 integrally coupled to the container 400 and ensuring a tight seal; moreover, the grooved side wall of the cylinder is coupled by interference fit to the inner surface of the longitudinal cavity defined by the respective longitudinal hollow cylinder (218). When the mechanical valve device is inserted into the receiver 100 and the dispenser cap (300) is coupled to the receiver 100 (by screwing the locking ferrule 310 onto the thread 101 of the receiver 100), the bottom cylinder (333) of the unlocking element (330) interacts with the perforated top flanges (266) of such at least partial occlusion elements pushing the perforated top flanges (266) themselves and, consequently, such at least partial occlusion elements downwards (similarly to what shown in FIG. 10 for the occlusion hollow cylinders 265), whereby each one of such at least partial occlusion elements is inserted into the longitudinal cavity defined by the respective longitudinal hollow cylinder (218) with the perforated top flange (266) resting onto the locking cover (250) and with the solid cylindrical bottom head projecting and being spaced apart from the longitudinal cavity itself (while the grooved side wall of the cylinder continues to be coupled by interference fit to the inner surface of the longitudinal cavity defined by the respective longitudinal hollow cylinder). As a consequence, the longitudinal cavity is in communication, through the helicoidal groove on the side wall of the cylinder of each one of such at least partial occlusion elements, with the inside of the container 400 and, through the holes of the perforated flange (266), with the vent apertures (325). In such configuration, each one of such at least partial occlusion elements allows the passage of large quantities of gaseous fluids, permitting the dispensing of a liquid contained in the container 400 even with high volumetric flow rates without creating any pressure drop inside the container 400. In other words, also with such at least partial occlusion elements, the closed loop dispensing system according to the invention acts as a valve that is either entirely closed (similarly to what shown in FIG. 9 for the second embodiment), tightly closing the container 400, or entirely open (similarly to what shown in FIG. 10 for the second embodiment), permitting the dispensing of a liquid contained in the container 400 even with high volumetric flow rates.

Also in this case, elastic return devices may be present which allow such at least partial occlusion elements to return in the configuration in which the solid cylindrical bottom head of each one of such at least partial occlusion elements and the inner surface of the longitudinal cavity defined by the respective longitudinal hollow cylinder (218) are in contact with each other and ensure a sealed interference fit (similarly to what shown in FIG. 9 for the second embodiment) after the dispenser cap 300 is removed from the receiver 100, permitting to use such closed loop dispensing system with higher safety. In this case, it is not necessary that the grooved side wall of the cylinder is coupled by interference fit to the inner surface of the longitudinal cavity defined dal respective longitudinal hollow cylinder (218), and advantageously the top surface of the solid cylindrical bottom head can be tapered to facilitate the return of the solid cylindrical bottom head inside the respective longitudinal hollow cylinder (218). By way of example, and not by way of limitation, such elastic return devices can be compression springs wrapped around the top end portion of the cylinder with helicoidal groove on the side wall of such at least partial occlusion elements and interposed between the top surface of the disc (251) of the locking cover (250) and the top flanges (266) of the respective at least partial occlusion elements.

It must be noted that in other embodiments of the closed loop dispensing system according to the invention, the number of snap-fit coupling wings 324 can be different from six, namely it can be any number larger than or equal to two, optionally larger than or equal to three. Similarly, in further embodiments of the closed loop dispensing system according to the invention, the number of vent apertures 325 can be different from six, namely it can be any number larger than or equal to one, and the vent apertures can be also arranged not in correspondence with the snap-fit coupling wings 324 and even not or not only between the snap-fit coupling wings 324 and the sleeve 323, for instance even between the snap-fit coupling wings 324 and the cylindrical wall 321.

It must be noted that in further embodiments of the closed loop dispensing system according to the invention, the top cylinder 332 of the unlocking member 330 and the sleeve 323 of the covering cap 320, which have substantially cylindrical shape, can be replaced with collars having non-cylindrical shapes corresponding to each other, e.g. prism shapes corresponding to each other, and/or the bottom cylinder 333 of the unlocking member 330 and the sleeve 253 of the locking cover, which have substantially cylindrical shape, can be replaced with collars having non-cylindrical shapes corresponding to each other, e.g. prism shapes corresponding to each other.

Also, it must be noted that in additional embodiments of the closed loop dispensing system according to the invention, the top cylinder 332 (or more generally the top collar) of the unlocking member 330 can be configured to slide onto the inner surface, instead of the outer surface, of the sleeve 323 (or more generally of the respective collar) of the covering cap 320, and/or the bottom cylinder 333 (or more generally the bottom collar) of the unlocking member 330 can be configured to slide onto the inner surface, instead of the outer surface, of the sleeve 253 (or more generally of the respective collar) of the locking cover.

Although the cylindrical symmetry shape of the components illustrated for the first and second embodiments of the closed loop dispenser system according to the invention allows a simpler manufacture and an easier use, nevertheless it must be noted that, in further embodiments of the closed loop dispenser system according to the invention, the components having substantially cylindrical symmetry shapes, such as for instance the locking ferrule 310 (and the respective receiver 100), the body 211 and the collar 215 con the top flange 216 of the cup-shaped base 210, as well as the related ledge 217, the various portions of the outline of the plate 221, the disc 251 of the locking cover 250 and the related central circular hole 252 can have different shapes, for instance prism shapes.

The preferred embodiments of this invention have been described and a number of variations have been suggested hereinbefore, but it should be understood that those skilled in the art can make other variations and changes without so departing from the scope of protection thereof, as defined by the attached claims.

1. Closed loop dispensing system comprising a mechanical valve device, configured to be inserted into a receiver integrally coupled to a container in correspondence with an access aperture thereof, and a dispenser cap configured to be coupled to the receiver, wherein the mechanical valve device has a longitudinal axis and comprises
a cup-shaped base configured to be inserted into the receiver and closed by a bottom having an inlet aperture configured to be inserted into the container, when the mechanical valve device is inserted into the receiver, the cup-shaped base being provided with one or more longitudinal tunnels which house respective one or more at least partial occlusion elements,
a spring support, that is coupled to the cup-shaped base and that is spaced apart from the bottom of the cup-shaped base, wherein the spring support is provided with a spring support top sleeve, the spring support being configured to put the inlet aperture in fluid communication with an outer surface of the spring support top sleeve,
a movable sealing dome slidingly coupled to the spring support top sleeve ensuring a seal between the movable sealing dome and the spring support top sleeve, whereby the spring support top sleeve and the movable sealing dome define a variable volume sealed chamber that houses an elastic element supported by the cup-shaped base, wherein the elastic element assumes an elongated configuration when said chamber assumes an enlarged configuration having a first volume and a compressed configuration when said chamber assumes a reduced configuration having a second volume lower than the first volume, and
a locking cover resting on the cup-shaped base and having a locking cover top sleeve surrounding a hole, wherein an edge of the hole and the movable sealing dome are configured to be in contact with each other by sealed interference fit when the elastic element assumes the elongated configuration, and wherein the dispenser cap, having an outlet aperture and one or more vent apertures, comprises an unlocking member having a bottom cylinder and a bottom central duct that is arranged inside the bottom cylinder and is in fluid communication with the outlet aperture, wherein, when the mechanical valve device is inserted into the receiver and the dispenser cap is decoupled from the receiver, said chamber assumes the enlarged configuration and the inlet aperture is in fluid communication with die cup-shaped base up to a bottom surface of the locking cover with the hole closed by the interference seal betw een the edge of the hole and the movable sealing dome, and wherein, when the mechanical valve device is inserted into the receiver and the dispenser cap is coupled to the receiver, the bottom cylinder is coupled by interference fit to the locking cover top sleeve and the bottom central duct interacts with the movable sealing dome causing said chamber to assume the reduced configuration, whereby the inlet aperture is in fluid communication with the outlet aperture, and said one or more at least partial occlusion elements are configured to cause the container to be in fluid communication with said one or more vent apertures.

2. Closed loop dispensing system according to claim 1, wherein cui said one or more at least partial occlusion elements are one or more labyrinth inserts inserted into said one or more longitudinal tunnels and configured to stably remain therein thanks to an interference fit between an outer surface of each labyrinth insert and an inner surface of the respective longitudinal tunnel, said one or more labyrinth inserts being configured to partially occlude said one or more longitudinal tunnels and to make a laby rinth seal.

3. Closed loop dispensing system according to claim 1, wherein, when the mechanical valve device is inserted into the receiver and the dispenser cap is decoupled from the receiver, said one or more at least partial occlusion elements are configured to seal said one or more longitudinal tunnels, whereby the container is not in fluid communication with said one or more vent apertures.

4. Closed loop dispensing system according to claim 3, wherein, when the mechanical valve device is inserted into the receiver, after the dispenser cap has been coupled to the receiver for a first time, said one or more at least partial occlusion elements are configured to cause the container to remain in fluid communication with said one or more vent apertures when the dispenser cap is removed from the receiver.

5. Closed loop dispensing system according to claim 3, wherein said one or more longitudinal tunnels are one or more longitudinal hollow cylinders and said one or more at least partial occlusion elements are one or more hollow cylinders inserted into said one or more longitudinal hollow cylinders, respectively, wherein each one of said one or more hollow cylinders is configured to stably remain in the respective longitudinal hollow cylinder, in absence of external forces exerted on said one or more hollow cylinders, thanks to an interference fit between an outer surface of each one or more at least partial occlusion hollow cylinder and an inner surface of the respective longitudinal hollow cylinder, each one of said one or more hollow cylinders being provided with a bottom aperture, wherein, when the mechanical valve device is inserted into the receiver and the dispenser cap is coupled to the receiver, the bottom aperture of each one of said one or more hollow cylinders is in fluid communication with the container.

6. Closed loop dispensing system according to claim 5, wherein each one of said one or more hollow cylinders is provided with a top flange, wherein, when the mechanical valve device is inserted into the receiver and the dispenser cap is decoupled from the receiver, said one or more hollow cylinders are inserted into said one or more longitudinal hollow cylinders with a top end protruding from a top surface of the locking cover, whereby the top flange of each one of said one or more hollow cylinders is spaced apart from the locking cover, and wherein, when the mechanical valve device is inserted into the receiver and the dispenser cap is coupled to the receiver (100), the bottom cylinder of the unlocking member interacts with the top flange of each one of said one or more hollow cylinders pushing them towards the locking cover and causing a bottom end of said one or more hollow cylinders to protrude from the bottom of the cup-shaped base.

7. Closed loop dispensing system according to claim 6, when depending on claim 3, wherein each one of said one or more hollow cylinders is provided with an elastic return device interposed between the top surface of the locking cover and the top flange that is configured to interact with the top flange and to cause, when the mechanical valve device is inserted into the receiver and the dispenser cap is decoupled from the receiver, the top end of the respective hollow cylinder to protrude from the top surface of the locking cover.

8. Closed loop dispensing system according to claim 3, wherein said one or more longitudinal tunnels are one or more longitudinal hollow cylinders, each one of which has a longitudinal cavity, and each one of said one or more at least partial occlusion elements comprises a cylinder having a grooved side wall comprising^{,} at least one groove, wherein the cylinder ends with a solid cylindrical bottom head, wherein said one or more at least partial occlusion elements are inserted in said one or more longitudinal hollow cylinders, respectively, wherein each one of said one or more at least partial occlusion elements is configured to stably remain in the respective longitudinal hollow cylinder, in absence of external forces exerted on said one or more at least partial occlusion elements, thanks to an interference fit between an outer surface of the solid cylindrical bottom head of each one of said one or more occlusion elements and an inner surface of the respective longitudinal hollow cylinder, wherein, when the mechanical valve device is inserted into the receiver and the dispenser cap is coupled to the receiver, the solid cylindrical bottom head of each one of said one or more at least partial occlusion elements projects and is spaced apart from the longitudinal cavity of the respective longitudinal hollow cylinder, whereby the longitudinal cavity of each one of said one or more longitudinal hollow cylinders is in fluid communication, through said at least one groove on the grooved side wall of the cylinder of each one of said one or more at least partial occlusion elements, with the container.

9. Closed loop dispensing system according to claim 8, wherein each one of said one or more at least partial occlusion elements is provided with a perforated top flange, wherein, when the mechanical valve device is inserted into the receiver and the dispenser cap is decoupled from the receiver, said one or more at least partial occlusion elements are inserted into said one or more longitudinal hollow cylinders with a top end protruding from a top surface of the locking cover, whereby the perforated top flange of each one of said one or more at least partial occlusion elements is spaced apart from the locking cover, and wherein, when the mechanical valve device is inserted into the receiver and the dispenser cap is coupled to the receiver, the bottom cylinder of the unlocking element interacts with the perforated top flange of each one of said one or more at least partial occlusion elements pushing it towards the locking cover and causing the solid cylindrical bottom head of each one of said one or more at least partial occlusion elements to project and to be spaced apart from the longitudinal cavity of the respective longitudinal hollow cylinder, whereby the longitudinal cavity of each one of said one or more longitudinal hollow cylinders is in fluid communication, through said at least one groove on the grooved side wall of the cylinder of each one of said one or more at least partial occlusion elements, with the container and, through holes of the perforated flange, with said one or more vent apertures.

10. Closed loop dispensing system according to claim 9, wherein each one of said one or more at least partial occlusion elements is provided with an elastic return device interposed between the top surface of the locking cover and the perforated top flange that is configured to interact with the perforated top flange and to cause, when the mechanical valve device is inserted into the receiver and the dispenser cap is decoupled from the receiver, the top end of the respective at least partial occlusion element to project from the top surface of the locking cover.

11. Closed loop dispensing system according to claim 1, wherein the locking cover is attached to the cup-shaped base through ultrasonic welding.

12. Closed loop dispensing system according to claim 1, wherein
the cup-shaped base has a substantially cylindrical body closed by the bottom that is provided with a hollow support protruding outward from the bottom, whereby a cavity of the hollow support acts as inlet aperture of the bottom, wherein a top of the body of the cup shaped base is open and provided with a substantially cylindrical collar having diameter greater than that of the body and provided with a ring-shaped top flange extending outward, the collar joining with the body through a ring-shaped ledge, wherein the collar is configured to be slidingly coupled by interference fit to the receiver when the mechanical valve device is inserted into the receiver until the top flange abuts an inlet edge of the receiver, the body comprising said one or more longitudinal tunnels extending between the bottom and the ring-shaped ledge,
wherein the spring support has a plate from which the spring support top sleeve protrudes, an outline of the plate having one or more portions corresponding to outer surfaces of said one or more longitudinal tunnels directed internally to the body and being provided with one or more notches configured to put the inlet aperture in fluid communication with an outer surface of the spring support top sleeve,
wherein the movable sealing dome has a substantially cylindrical body and a top end closed by a frustoconical lateral surface and by an apical disc, wherein the locking cover comprises a substantially circular disc provided with the hole having a circumference corresponding to an inner cylindrical surface of the collar, whereby the disc is configured to rest on the ring-shaped ledge, the disc being provided with one or more recesses configured to overlap said one or more longitudinal tunnels, wherein the edge of the hole of the disc and the frustoconical lateral surface of the movable sealing dome are configured to be in contact by sealed interference fit with each other when the elastic element assumes the elongated configuration,
wherein the dispenser cap comprises a substantially circular locking ferrule, having a bottom aperture and a top aperture, and a covering cap coupled by snap-fit to the ferrule in correspondence to the top aperture and that is provided with said one or more vent apertures and with a hollow support, that protrudes outward from a top surface of the covering cap, whereby a cavity of the hollow support acts as outlet aperture of the dispenser cap
wherein the unlocking member includes a perforated plate from which a top cylinder and the bottom cylinder protrude in opposite directions, the covering cap being coupled by snap-fit to the top cylinder.

13. Closed loop dispensing system according to claim 12, wherein the dispenser cap further comprises a flexible umbrella valve having a stem housed in the bottom central duct.

14. Kit of components for making a closed loop dispensing system according to, comprising:
a cup-shaped base configured to be inserted into the receiver and closed by a bottom having an inlet aperture, the cup-shaped base being provided with one or more longitudinal tunnels;
one or more at least partial occlusion elements configured to be housed in said one or more longitudinal tunnels, respectively,
a spring support, configured to be coupled to the cup-shaped base and to be spaced apart from the bottom of the cup-shaped base, wherein the spring support is provided with a spring support top sleeve, the spring support being configured to put the inlet aperture in fluid communication with an outer surface of the spring support top sleeve,
a movable sealing dome configured to be slidingly coupled to the spring support top sleeve ensuring a seal between the movable sealing dome and the spring support top sleeve,
an elastic element configured to be housed in a variable volume sealed chamber defined by the spring support top sleeve and the movable sealing dome and to be supported by the cup-shaped base,
a locking cover configured to be resting on the cup-shaped base and having a locking cover top sleeve surrounding a hole, wherein an edge of the hole and the movable sealing dome are configured to be in contact with each other by sealed interference fit, and
a dispenser caps, having an outlet aperture and one or more vent apertures, and comprising an unlocking member having a bottom cylinder and a bottom central duct that is arranged inside the bottom cylinder and configured to be in fluid communication with the outlet aperture.
